(19) United States
(12) Patent Application Publication
(10) Pub. No.: US 2018/0004977 A1
(43) Pub. Date: Jan. 4, 2018

(54) INFORMATION PROCESSING APPARATUS, METHOD, AND PROGRAM

(71) Applicant: SONY CORPORATION, Tokyo (JP)

(72) Inventor: Yoshinori TAKAGI, Kanagawa (JP)

(73) Assignee: SONY CORPORATION, Tokyo (JP)

(21) Appl. No.: 15/543,072

(22) PCT Filed: Jan. 6, 2016
(86) PCT No.: PCT/JP2016/050208

§ 371 Date: Jul. 12, 2017

(30) Foreign Application Priority Data
Jan. 19, 2015 (JP) 2015-007355

(51) Int. Cl. G06F 21/62; H04L 9/08

(52) U.S. Cl. CPC G06F 21/6254; H04L 9/0866

(57) ABSTRACT

The present technology relates to an information processing apparatus, a method, and a program that can improve anonymity. An acquisition unit acquires a user identification ID that identifies a user and user data regarding the user. A derived ID generation unit carries out an operation using a one-way function, for data obtained from the user identification ID according to an increase in the number of the user data recorded in a recording unit, to generate a derived ID. A recording control unit causes the recording unit to record the generated derived ID and the acquired user data in association with each other to. In this way, the derived ID is generated according to the increase in the number of recorded user data, and the user data is recorded in association with the derived ID. Therefore, K-anonymity of the user data can be improved. The present technology can be applied to a server.

### TECHNICAL FIELD

The present technology relates to an information processing apparatus, a method, and a program, and especially relates to an information processing apparatus, a method, and a program that can improve anonymity.

### BACKGROUND ART

Conventionally, in servers and the like that manage data of a plurality of users, the data are anonymized so that which data to be managed by the servers and the like pertains to which user cannot be identified by a third party.

For example, a technology that generates, for each service, a service ID for a user identified with a user ID, records the user ID and the service ID in association with each other, and records data regarding each service in association with the service ID has been proposed (for example, see Patent Document 1).

Further, a technology that applies a one-way function to a personal ID number, which identifies a user, to generate an anonymization number, and then discards a table of the personal ID number and the anonymization number has also been proposed (for example, see Patent Document 2).

If personal data of a user is recorded in association with such a service ID or an anonymization number, it is difficult to identify which data belongs to which user from the data, the service ID or the anonymization number.

### CITATION LIST

### Patent Document

Patent Document 1: Japanese Patent Application Laid-Open No. 2009-266194
Patent Document 2: International Publication No. WO 2008/069011

### SUMMARY OF THE INVENTION

### Problems to be Solved by the Invention

However, in the above-described technologies, if the number of data recorded in association with the service ID or the anonymization is large, the number of users conceivable from combinations of the data becomes small, and thus anonymity, especially, K-anonymity becomes low.

Further, in the technology described in Patent Document 1, the service ID is generated for each service and is recorded in association with data. However, in a case where a malicious third party gets the user ID and the service ID recorded in association with each other, the third party can identify which service ID pertains to which user ID. Therefore, it cannot be said that sufficient anonymization has been done.

The present technology has been made in view of the foregoing, and can improve anonymity.

### Solutions to Problems

An information processing apparatus of a first aspect of the present technology includes: an acquisition unit configured to acquire personal identification information that identifies a user and data to be recorded; a derived identification information generation unit configured to generate derived identification information from the personal identification information on the basis of the number of already recorded recorded data; and a recording control unit configured to control such that the derived identification information or the personal identification information, and the data to be recorded are recorded in association with each other.

The derived identification information generation unit can generate the derived identification information by carrying out an operation using a one-way function for the personal identification information.

The derived identification information generation unit can generate the derived identification information from the already recorded recorded data and the personal identification information.

The derived identification information generation unit can generate new derived identification information every time a predetermined number of the data to be recorded is recorded as the recorded data.

The predetermined number can be changed according to the number of the recorded data.

The recording control unit can control such that the data to be recorded are recorded in association with the personal identification information or the generated derived identification information on the basis of the number of the recorded data recorded in association with the generated derived identification information, and the number of the recorded data recorded in association with the personal identification information.

An information processing apparatus of a second aspect of the present technology includes: an acquisition unit configured to acquire personal identification information that identifies a user and data to be recorded; a derived identification information generation unit configured to generate derived identification information from the personal identification information on the basis of the data to be recorded; and a recording control unit configured to control such that the derived identification information or the personal identification information, and the data to be recorded are recorded in association with each other.

The derived identification information generation unit can generate the derived identification information from already recorded recorded data and the personal identification information.

The derived identification information generation unit can generate the derived identification information by carrying out an operation using a one-way function for data obtained from most recently recorded recorded data and the personal identification information.

The derived identification information generation unit can generate the derived identification information on the basis of a type or recording date and time of the data to be recorded.

The derived identification information generation unit can generate the derived identification information in a case where the data to be recorded acquired from the acquisition unit is different from predetermined data to be recorded.

The recording control unit can control such that the data to be recorded are recorded in association with the personal identification information or the derived identification information on the basis of the data to be recorded.

An information processing method or program of the first aspect of the present technology includes the steps of: acquiring personal identification information that identifies a user and data to be recorded; generating derived identification information from the personal identification information on the basis of the number of already recorded recorded data; and controlling such that the derived identification information or the personal identification information, and the data to be recorded are recorded in association with each other.

In the first aspect of the present technology, personal identification information that identifies a user and data to be recorded are acquired, derived identification information is generated from the personal identification information on the basis of the number of already recorded recorded data, and the derived identification information or the personal identification information and the data to be recorded are recorded in association with each other.

An information processing method or program of the second aspect of the present technology includes the steps of: acquiring personal identification information that identifies a user and data to be recorded; generating derived identification information from the personal identification information on the basis of the data to be recorded; and controlling such that the derived identification information or the personal identification information, and the data to be recorded are recorded in association with each other.

In the second aspect of the present technology, personal identification information that identifies a user and data to be recorded are acquired, derived identification information is generated from the personal identification information on the basis of the data to be recorded, and the derived identification information or the personal identification information and the data to be recorded are recorded in association with each other.

An information processing apparatus of a third aspect of the present technology is an information processing apparatus that generates derived identification information from personal identification information that identifies a user on the basis of the number of already recorded record data, and reads out the record data recorded in a recording unit in association with the derived identification information or the personal identification information, the information processing apparatus including: a derived identification information generation unit configured to generate the derived identification information from the personal identification information; and a readout unit configured to read out the record data recorded in association with the generated derived identification information or the personal identification information.

The derived identification information generation unit can generate the derived identification information by carrying out an operation using a one-way function for the personal identification information.

The derived identification information generation unit can generate the derived identification information from the record data recorded in association with the personal identification information and the personal identification information.

The derived identification information generation unit can generate the derived identification information from a predetermined number and the personal identification information.

The derived identification information generation unit can change the predetermined number at constant intervals or unfixed intervals.

The derived identification information generation unit can generate the derived identification information on the basis of the number of the record data recorded in association with the personal identification information.

In the third aspect of the present technology, in an information processing apparatus that generates derived identification information from personal identification information that identifies a user on the basis of the number of already recorded record data, and reads out the record data recorded in a recording unit in association with the derived identification information or the personal identification information, the derived identification information is generated from the personal identification information, and the record data recorded in association with the generated derived identification information or the personal identification information is read out.

An information processing apparatus of a fourth aspect of the present technology is an information processing apparatus that generates derived identification information from personal identification information that identifies a user on the basis of record data that is an object to be recorded, and reads out the record data recorded in a recording unit in association with the derived identification information or the personal identification information, and the information processing apparatus includes a derived identification information generation unit configured to generate the derived identification information from the personal identification information, and a readout unit configured to read out the record data recorded in association with the generated derived identification information or the personal identification information.

The derived identification information generation unit can generate the derived identification information from the record data recorded in association with the personal identification information and the personal identification information.

The derived identification information generation unit can generate the derived identification information by carrying out an operation using a one-way function for data obtained from the record data recorded in association with the personal identification information and the personal identification information.

The derived identification information generation unit can generate the derived identification information on the basis of a type or recording date and time of the record data recorded in association with the personal identification information.

In the fourth aspect of the present technology, in an information processing apparatus that generates derived identification information from personal identification information that identifies a user on the basis of record data that is an object to be recorded, and reads out the record data recorded in a recording unit in association with the derived identification information or the personal identification information, the derived identification information is generated from the personal identification information, and the record data recorded in association with the generated derived identification information or the personal identification information is read out.

### Effects of the Invention

According to the first to fourth aspects of the present technology, anonymity can be improved.

Note that the effects described here are not necessarily limited, and may be any of effects described in the present disclosure.

### BRIEF DESCRIPTION OF DRAWINGS

FIG. 1 is a diagram illustrating a configuration example of a data management apparatus.

FIG. 2 is a diagram illustrating recording of user data.

FIG. 3 is a flowchart illustrating a data recording process.

FIG. 4 is a flowchart illustrating a readout process.

FIG. 5 is a diagram illustrating recording of user data.

FIG. 6 is a flowchart illustrating a data recording process.

FIG. 7 is a flowchart illustrating a readout process.

FIG. 8 is a diagram illustrating recording of user data.

FIG. 9 is a flowchart illustrating a data recording process.

FIG. 10 is a flowchart illustrating a readout process.

FIG. 11 is a diagram illustrating recording of user data.

FIG. 12 is a flowchart illustrating a data recording process.

FIG. 13 is a flowchart illustrating a readout process.

FIG. 14 is a diagram illustrating a configuration example of a computer.

### MODE FOR CARRYING OUT THE INVENTION

Hereinafter, embodiments to which the present technology has been applied will be described with reference to the drawings.

### First Embodiment

### <Configuration Example of Data Management Device>

The present technology can improve anonymity of deposited data of a user in managing the deposited data.

For example, when data regarding a predetermined user is recorded in association with user identification ID that identifies the predetermined user, K-anonymity becomes lower as a larger number of data associated with the user identification ID is accumulated even if the user identification ID is information with high anonymity.

Therefore, the present technology appropriately generates, in managing data regarding a user, a derived ID, using some sort of algorithm according to an increase in the number of data, and records the data in association with the derived ID, thereby to improve anonymity.

Especially, only a management side of the data, who knows the algorithm, can identify which derived ID belongs to which user, and a malicious third party cannot associate the derived IDs and users, whereby the K-anonymity can be improved.

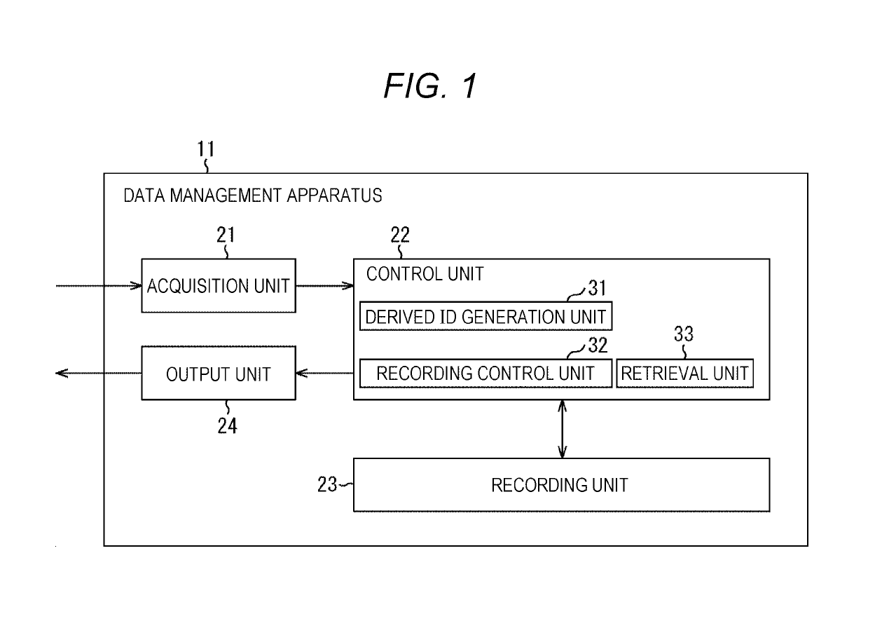

Next, an embodiment to which the present technology has been applied will be more specifically described. FIG. 1 is a diagram illustrating a configuration example of an embodiment of a data management apparatus to which the present technology has been applied.

A data management apparatus 11 illustrated in FIG. 1 is an information processing apparatus such as a server that manages data of a plurality of users, for example. The data management apparatus 11 manages data regarding users (hereinafter, the data are referred to as user data) on the basis of user identification IDs that identify the users.

When the data management apparatus 11 receives a recording request of the user data, for example, from an information terminal apparatus owned by the user, from an information terminal apparatus of a service provider who provides a service to the user or the like, the data management apparatus 11 acquires the user identification ID and the user data from the information terminal apparatus, and records the user data.

Further, for example, when the data management apparatus 11 receives a readout request of the user data from the information terminal apparatus, the data management apparatus 11 acquires the user identification ID from the information terminal apparatus and retrieves the user data, and outputs the user data obtained as a result of a retrieval result to the information terminal apparatus.

Here, the user identification ID is identification information that uniquely can identify the user, but typically, the user identification ID is information from which the user identified with the user identification ID cannot be identified (identification is difficult) only if somebody else gets the user identification ID. Here, the user identification ID is information of a predetermined bit number made of numerals and symbols, for example.

Further, the user data may be any data such as data regarding a service provided to the user. For example, the user data may be data that indicates a test result regarding health such as a blood test, data regarding exercise measured in a fitness club or the like, or data regarding medical care such as a drug taken by the user.

Further, hereinafter, the user data recorded in the data management apparatus 11 is especially referred to as recorded user data, and the user data to be recorded in the data management apparatus 11, of which the recording request has been received, is also referred to as user data to be recorded.

The data management apparatus 11 includes an acquisition unit 21, a control unit 22, a recording unit 23, and an output unit 24.

The acquisition unit 21 acquires the user identification ID and the user data, as needed, from the information terminal apparatus connected through a network, and supplies the user identification ID and the user data to the control unit 22.

The control unit 22 records the user data in the recording unit 23, and reads out the user data from the recording unit 23 and supplies the user data to the output unit 24, on the basis of the user identification ID and the user data supplied from the acquisition unit 21. The control unit 22 includes a derived ID generation unit 31, a recording control unit 32, and a retrieval unit 33. Note that these derived ID generation unit 31 to retrieval unit 33 can transfer information to one another.

The derived ID generation unit 31 generates the derived ID, using at least the user identification ID, according to an increase in the number of recorded user data of the user identified with the user identification ID. Here, the derived ID is used as a substitute for the user identification ID in recording the user data, and is information with sufficiently high anonymity. That is, the derived ID is used to identify which user's data the recorded user data is.

The recording control unit 32 supplies the derived ID and the user data to the recording unit 23, and controls recording of the user data. That is, the recording control unit 32 records the derived ID and the user data in association with each other in the recording unit 23.

The retrieval unit 33 retrieves the user data recorded in association with the derived ID in the recording unit 23, on the basis of the derived ID generated by the derived ID generation unit 31, and reads out the user data obtained through the retrieval from the recording unit 23, as needed.

The recording unit 23 records various data such as the user data supplied from the control unit 22, and supplies the recorded user data and the like to the control unit 22, on demand. The output unit 24 transmits the user data supplied from the control unit 22 to the information terminal apparatus connected through a network.

### <Recording of User Data>

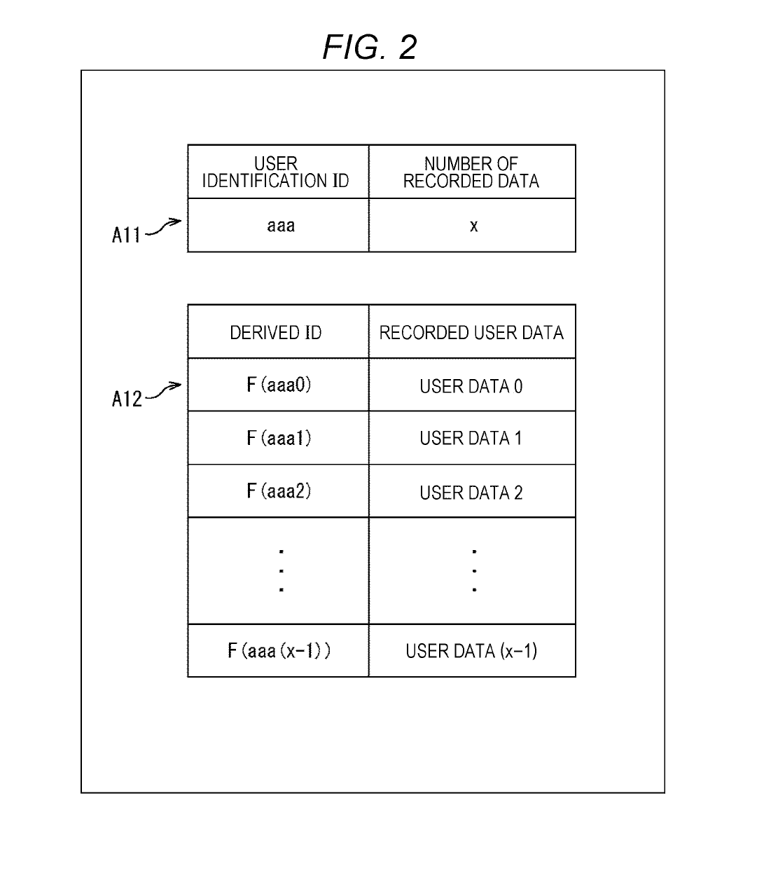

Further, the user data is recorded in the recording unit 23, as illustrated in FIG. 2, for example.

That is, in the example illustrated in FIG. 2, the user identification ID and the number of recorded data x, which indicates the number of recorded user data of the user identified with the user identification ID, are recorded in association with each other in the recording unit 23, as illustrated by the arrow A11. Then, the derived ID is generated according to a value of the number of recorded data x, and the derived ID and new user data are recorded in association with each other in the recording unit 23, as illustrated by the arrow A12.

In this example, “aaa” as the user identification ID of a specific user, and the number of recorded data “x”, which indicates the number of all recorded user data of the user, are recorded in association with each other.

For example, in a case where recording of “user data 0” is requested as the user data to be recorded in a state of the number of recorded data x=0, the derived ID generation unit 31 generates the derived ID on the basis of the user identification ID “aaa” and the number of recorded data “x=0”.

To be specific, for example, the derived ID generation unit 31 assigns a value “aaa0”, which is obtained by adding the value of the number of recorded data x to the tail end of the user identification ID, to a predetermined one-way function F as an argument, and employs a value F(aaa0) obtained as a result of the operation as the derived ID. Then, the recording control unit 32 causes the recording unit 23 to record the obtained derived ID “F(aaa0)” and the “user data 0” as the user data to be recorded in association with each other, and then updates the value of the number of recorded data x.

Here, the one-way function F used to generate the derived ID may be any function as long as obtainment of the original argument from the operation result of the function is difficult, such as a one-way hash function of a Secure Hash Algorithm (SHA)-256, for example. Further, here, the example in which the value obtained by combining the user identification ID and the number of recorded data x is used as the argument of the one-way function F is described. However, the value used as the argument of the one-way function F may be any value as long as the value can be obtained from the user identification ID and the number of recorded data x.

In this way, the data management apparatus 11 generates the derived ID on the basis of the user identification ID and the number of recorded data x and records the user data every time receiving the recording request of the user data. That is, a serial number is provided to the tail of the user identification ID, and the derived ID is calculated.

Therefore, in this example, the respective user data are recorded in association with the derived IDs that are different from one another. In other words, the derived ID is generated for each user data. In the example illustrated by the arrow A12, “user data 0” to “user data (x−1)” are recorded as the user data in association with the respective derived IDs “F(aaa0)” to “F(aaa(x−1))”.

In this way, the derived ID is newly generated according to an increase in the number of recorded user data, and the user data is recorded in association with the derived ID, whereby the anonymity of the user data can be improved.

Especially, in the data management apparatus 11, the user data are not recorded more than necessary in association with the same derived ID. Therefore, even if the number of recorded user data is increased, deterioration in the K-anonymity is avoided.

Furthermore, in the data management apparatus 11, information that indicates association between the user identification ID and the respective derived IDs is not recorded, and the derived IDs are generated through the operation by the one-way function. Therefore, a third party who does not know the generation algorithm of the derived IDs cannot identify association relationship between the user identification ID and the derived IDs, that is, which derived IDs belong to the same user. Accordingly, the anonymity of managed data can be improved, and as a result, administrative security of data can be improved.

### <Description of Data Recording Process>

Next, an operation of the data management apparatus 11 will be described.

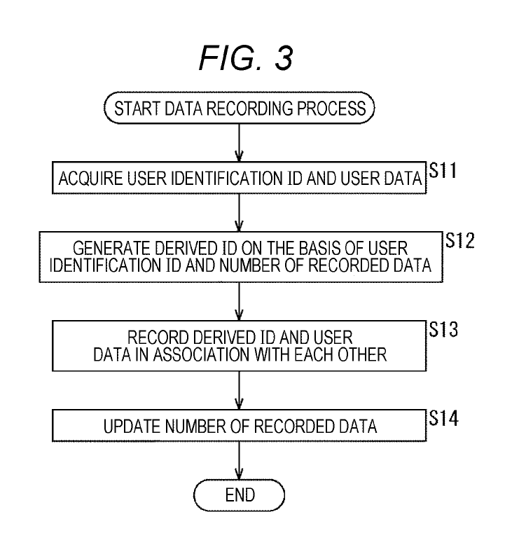

First, a data recording process performed when the data management apparatus 11 receives the recording request of the user data from the information terminal apparatus of the user or a service provider will be described with reference to the flowchart of FIG. 3.

In step S11, the acquisition unit 21 acquires, from the information terminal apparatus from which the recording request has been received, the user identification ID of the user and the user data that is an object to be recorded about the user, and supplies the user identification ID and the user data to the control unit 22. For example, the acquisition unit 21 acquires the user identification ID and the user data by receiving the user identification ID and the user data transmitted from the information terminal apparatus through the network such as the Internet.

In step S12, the derived ID generation unit 31 of the control unit 22 generates the derived ID on the basis of the user identification ID supplied from the acquisition unit 21, and the number of recorded data x recorded in association with the user identification ID in the recording unit 23.

For example, in the example described with reference to FIG. 2, the derived ID generation unit 31 uses the data obtained by combining the user identification ID and the number of recorded data x as the argument, and assigns the argument to the one-way function F and carries out an operation to generate the derived ID.

In step S13, the recording control unit 32 supplies the derived ID generated in the process of step S12 and the user data acquired in the process of step S11 to the recording unit 23, and causes the recording unit 23 to record the derived ID and the user data in association with each other.

In step S14, the recording control unit 32 updates the number of recorded data x recorded in the recording unit 23 in association with the user identification ID of the user whose user data has been recorded this time, that is, the user identification ID acquired in the process of step S11. That is, the value of the number of recorded data x is incremented by 1. Then, when the number of recorded data x is updated, the data recording process is terminated.

As described above, the data management apparatus 11 newly generates the derived ID from the user identification ID and the number of recorded data x, for the user data that is the objet to be recorded, and records the derived ID in association with the user data, every time performing the recording process of the user data. Accordingly, the anonymity, especially, the K-anonymity of the user data can be improved.

### <Description of Readout Process>

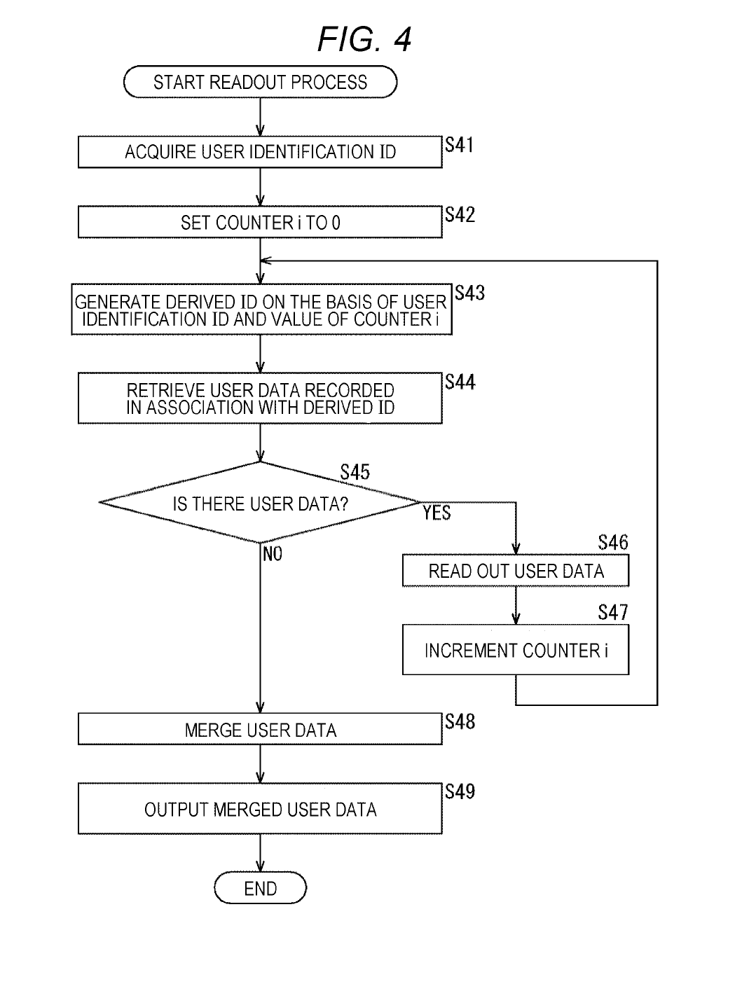

Further, for example, when the data management apparatus 11 receives the readout request of the user data from the information terminal apparatus of the user or the service provider, the data management apparatus 11 performs a readout process of reading out the user data from the recording unit 23, and outputting the user data to the information terminal apparatus. Hereinafter, the readout process by the data management apparatus 11 will be described with reference to the flowchart of FIG. 4.

In step S41, the acquisition unit 21 acquires, from the information terminal apparatus from which the readout request has been received, the user identification ID of the user, and supplies the user identification ID to the control unit 22. For example, the acquisition unit 21 acquires the user identification ID by receiving the user identification ID transmitted from the information terminal apparatus through the network such as the Internet.

In step S42, the derived ID generation unit 31 sets a value of a counter i to i=0, the value indicating a value (numerical value) used as the number of recorded data at the time of generation of the derived ID.

In step S43, the derived ID generation unit 31 generates the derived ID on the basis of the user identification ID supplied from the acquisition unit 21 and the value of the counter i.

For example, in the example described with reference to FIG. 2, the derived ID generation unit 31 considers the value of the counter i as the value of the number of recorded data x, and uses data obtained by combining the user identification ID and the value of the counter i as the argument. Then, the derived ID generation unit 31 assigns the obtained argument to the one-way function F and carries out an operation to generate the derived ID.

In step S44, the retrieval unit 33 retrieves the user data recorded in the recording unit 23 in association with the derived ID generated in the process of step S43.

In step S45, the retrieval unit 33 determines whether or not there is the user data associated with the derived ID. That is, whether there is the user data associated with the derived ID as a result of the retrieval in step S44 is determined.

In a case where it has been determined that there is the user data in step S45, the retrieval unit 33 reads out the user data associated with the derived ID, which has been found as the result of the retrieval, from the recording unit 23 and temporarily holds the user data in step S46.

In step S47, the derived ID generation unit 31 increments the value of the counter i by 1. Then, after that, the process returns to step S43, and the above-described processes are repeatedly performed. Therefore, when the process of step S47 is performed, the derived ID is generated using the new value of the counter i, and the user data associated with the derived ID is read out.

In the series of processes, the derived ID generation unit 31 performs the operation using the one-way function F, for the data obtained from the user identification ID and the value of the counter i, while changing the numerical value to be added to the tail end of the user identification ID, that is, the value of the counter i by 1, to generate the plurality of derived IDs. Accordingly, the derived IDs that would have been generated for the user identification ID are generated in order, and the user data recorded in association with the derived IDs are read out.

Further, in step S45, in a case where it has been determined that there is no user data, the process proceeds to step S48.

In this case, it means that all the derived ID actually generated in the data recording process, about the user identification ID, have been generated in the process of step S43, and the user data recorded in association with the derived IDs have been read out. That is, it means that all the user data recorded in the recording unit 23, about the user identified with the user identification ID, has been read out.

In step S48, the retrieval unit 33 merges all the user data obtained as a result of the retrieval, that is, all the user data read out in the process of step S46 (puts all the user data together), and supplies the merged user data to the output unit 24.

In step S49, the output unit 24 outputs the merged user data supplied from the retrieval unit 33 to the information terminal apparatus that has requested readout of the user data, and the readout process is terminated. For example, the output unit 24 transmits the merged user data to the information terminal apparatus through the network.

Note that, other than the method of merging and outputting the user data to the information terminal apparatus, a list of the user data obtained through retrieval may be output to the information terminal apparatus, and then only the user data selected from the list in the information terminal apparatus may be sent to the information terminal apparatus, in response to an instruction from the information terminal apparatus.

As described above, the data management apparatus 11 generates the derived ID on the basis of the user identification ID according to a predetermined algorithm, and reads out the user data recorded in association with the derived ID.

In this case, as described above, a third party who does not know the generation algorithm of the derived IDs cannot identify which derived IDs belong to the same user. In this way, only the management side of the user data can read out all the recorded user data about the user identification ID, whereby the anonymity of the user data can be improved.

Note that, in the readout process described with reference to FIG. 4, the case of generating the derived IDs in order while updating the value of the counter i has been described.

However, since the number of recorded data x is recorded in the recording unit 23, the derived ID generation unit 31 can identify all the derived IDs generated so far for the user identification ID by reference to the number of recorded data x.

Therefore, the derived ID generation unit 31 may generate all the derived IDs at a time on the basis of the user identification ID and the number of recorded data x, and the retrieval unit 33 may read out the user data associated with the derived IDs from the recording unit 23.

### Second Embodiment

### <Recording of User Data>

Further, in the example described in the first embodiment, a different derived ID is generated for each user data. Therefore, in reading out the user data, the process of generating the derived ID for each user data and performing the retrieval, and then putting together (merging) the user data associated with the derived IDs is required. Therefore, the processing amount becomes large if the number of the user data is large.

Therefore, one derived ID may be generated every time user data are recorded m times (hereinafter, referred to as interval m), instead of generating one derived ID for one user data. If the interval m to generate the derived ID is reasonably small, the processing amount at the time of readout of the user data can be reduced while K-anonymity of the user data is secured.

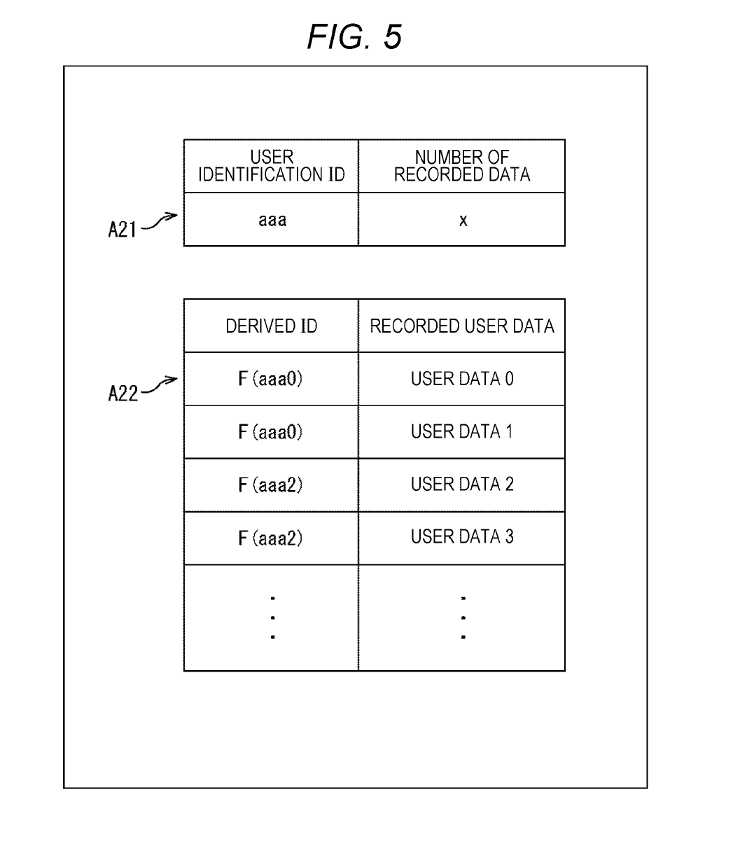

The interval m may be a constant value (fixed value) or a variable value. Hereinafter, a case in which the interval m is a constant value, and its value is the interval m=2 will be described. In such a case, the user data and the like are recorded in a recording unit 23, for example, as illustrated in FIG. 5.

That is, in this example, a user identification ID “aaa” and the number of recorded data “x” are recorded in association with each other in the recording unit 23, as illustrated by the arrow A21 of FIG. 5, similarly to the case in FIG. 2.

Further, F(aaap) (note that, p=0, 2, 4, . . . ) that are the derived IDs generated at the intervals m=2, and user data q (note that, q=0, 1, 2, . . . ) as the user data are recorded in association with each other in the recording unit 23, as illustrated by the arrow A22.

In this example, in a case where the number of recorded data x is a numeral mk composed of the interval m=2 and an integer k of 0 or more, that is, the number of recorded data x=0, 2, 4, 6, . . . , a new derived ID is generated.

In other words, in recording new user data, the derived ID is generated on the basis of the user identification ID and a value of a function G(x), where a value of the number of recorded data x is an argument, and a function that outputs an even number value not exceeding the value of the number of recorded data x is the function G(x). To be specific, a value obtained by adding a value of the function G(x) to the tail end of the user identification ID is used as the argument, and a value obtained by assigning the argument to a one-way function F is employed as the derived ID.

Here, the function G(x) is a function determined with the interval m. In this example, the interval m is the fixed value “2”, and thus the function G(x) is a function that outputs an even number value. Note that, here, the example in which the function G(x) is the function that outputs an even number value is described. However, the function G(x) may be any function as long as the function outputs a value according to the number of recorded data x at the intervals m.

For example, in a case where recording of the “user data 0” is requested as user data to be recorded, in a state where the number of recorded data x=0, the value of the function G(x) becomes “0”. Therefore, a derived ID generation unit 31 combines the user identification ID “aaa” and the value “0” of the function G(x) and assigns the combined value to the one-way function F, and employs a value “F(aaa0)” obtained as a result of the operation as the derived ID.

Then, a recording control unit 32 causes the recording unit 23 to record the obtained derived ID “F(aaa0)” and the “user data 0” as the user data to be recorded in association with each other, and then updates the number of recorded data x to x=1.

Further, in a case where recording of the “user data 1” is further requested as the user data to be recorded in the aforementioned state, the value of the function G(x) becomes “0” because of the number of recorded data x=1. Therefore, the “user data 1” as the user data is recorded in association with a derived ID “F(aaa0)” obtained from the user identification ID “aaa” and the function G(x). After that, the number of recorded data x is updated to x=2.

Then, in a case where recording of the “user data 2” is further requested as the user data in a state of the number of recorded data x=2, the value of the function G(x) becomes “2”, and thus a derived ID “F(aaa2)” is generated from the user identification ID “aaa” and the value “2” of the function G(x). Then, the “user data 2” is recorded in association with the derived ID “F(aaa2)”, and the number of recorded data x is updated to x=3.

In this way, the derived ID is newly generated every time the user data is recorded at the intervals m, that is, m times, whereby the processing amount at the time of readout of the user data can be reduced while anonymity of the user data is improved.

### <Description of Data Recording Process>

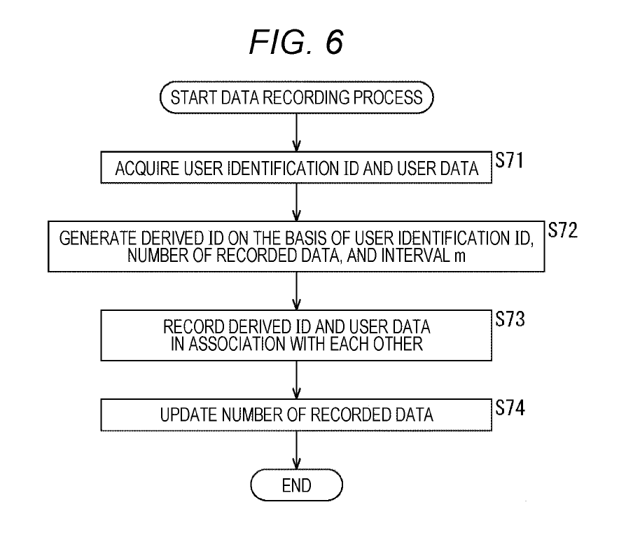

Next, a data recording process performed by a data management apparatus 11 in a case where the derived ID is generated at the constant intervals m will be described with reference to the flowchart of FIG. 6. Note that the process of step S71 is similar to the process of step S11 of FIG. 3, and thus description thereof is omitted.

In step S72, the derived ID generation unit 31 generates the derived ID on the basis of the user identification ID supplied from an acquisition unit 21, the number of recorded data x recorded in association with the user identification ID in the recording unit 23, and a predetermined interval m.

For example, in the example described with reference to FIG. 5, the derived ID generation unit 31 assigns the number of recorded data x to the function G(x) determined with the interval m, and employs data obtained by combining the value of the function G(x) obtained as a result of the operation and the user identification ID as the argument. Then, the derived ID generation unit 31 assigns the obtained argument to the one-way function F and carries out an operation to generate the derived ID.

When the derived ID is generated, then, the processes of steps S73 and S74 are performed and the data recording process is terminated. These processes are similar to the processes of steps S13 and S14 of FIG. 3, and thus description thereof is omitted.

As described above, the data management apparatus 11 newly generates the derived ID every time a constant number of user data is recorded on the basis of the interval m, and records the derived ID in association with the user data. Accordingly, the anonymity of the user data, especially, K-anonymity can be improved.

### <Description of Readout Process>

Next, a readout process performed in a case where the user data is recorded by the data recording process described with reference to FIG. 6 will be described.

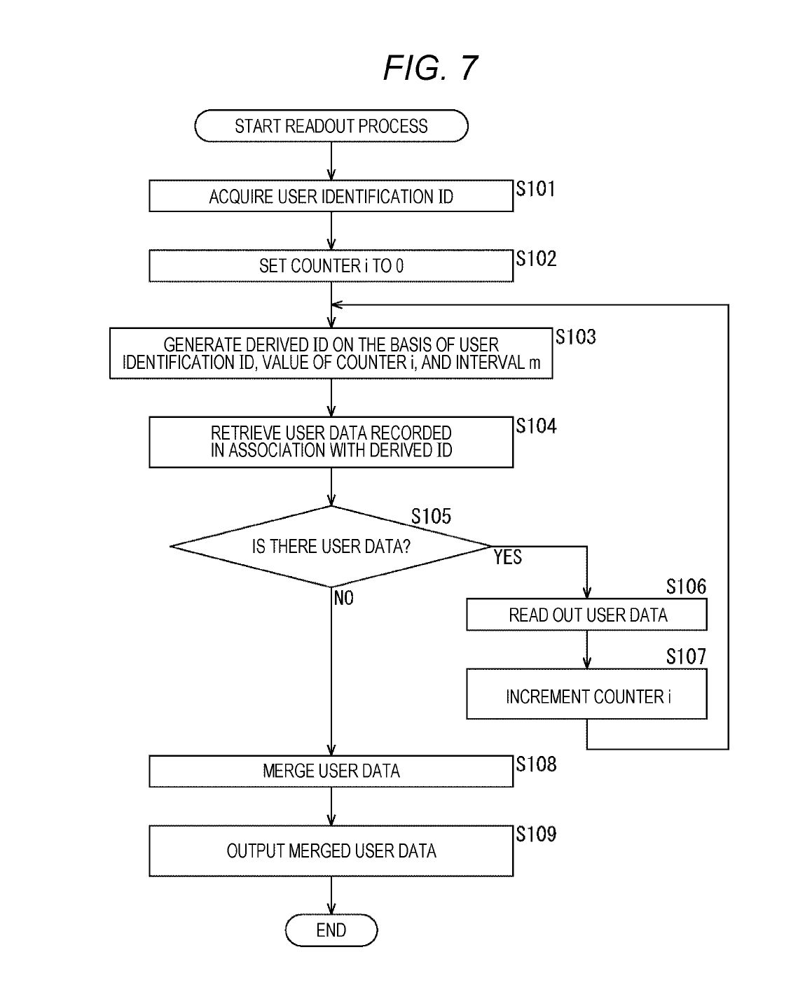

That is, hereinafter, the readout process performed by the data management apparatus 11 will be described with reference to the flowchart of FIG. 7.

Note that the processes of steps S101 and S102 are similar to the processes of steps S41 and S42 of FIG. 4, and thus description thereof is omitted. Note that, here, a value of a counter i is used to determine a numerical value to be added to the user identification ID at the time of generating the derived ID.

In step S103, the derived ID generation unit 31 generates the derived ID on the basis of the user identification ID supplied from the acquisition unit 21, the value of the counter i, and the predetermined interval m.

For example, the derived ID generation unit 31 considers a value mi obtained by multiplying the interval m by the value of the counter i as the value of the number of recorded data x, uses data obtained by combining the user identification ID and the value mi as the argument, and assigns the argument to the one-way function F and carries out an operation to generate the derived ID.

When the derived ID is generated, then, the processes of steps S104 to S109 are performed and the readout process is terminated. These processes are similar to the processes of steps S44 to S49 of FIG. 4, and thus description thereof is omitted.

In this case, for example, when the user data is read out in step S106, then, in step S107, the value of the counter i is incremented by 1, and a new derived ID is generated.

Therefore, when the processes of steps S103 to S107 are repeatedly performed, the derived IDs that would have been generated for the user identification ID are generated in order, and the user data recorded in association with the derived IDs are read out.

That is, in the series of processes, the derived ID generation unit 31 performs the operation using the one-way function F, for the data obtained from the user identification ID and the value mi while changing the numerical value to be added to the tail end of the user identification ID, that is, the value mi, at the constant intervals m, to generate the plurality of derived IDs.

Further, in this case also, all the derived IDs generated so far for the user identification ID can be identified by reference to the number of recorded data x. Therefore, all the derived IDs may be generated at a time, and the user data may be read out.

As described above, the data management apparatus 11 generates the derived ID on the basis of the user identification ID at the interval m, and reads out the user data recorded in association with the derived ID.

In this case also, a third party who does not know a generation algorithm of the derived ID cannot identify which derived IDs belong to the same user. In this way, only a management side of the user data can read out all the user data recorded about the user identification ID, whereby the anonymity of the user data can be improved.

Especially, in this example, a new derived ID is generated every time a constant number of user data is recorded in association with the same derived ID. Therefore, similar combinations are increased as combinations of the user data recorded in association with the derived IDs as the number of recorded user data is increased. Therefore, the K-anonymity can be improved.

Note that, in the above description, the case in which the interval m is the interval m=2 on a constant basis, and the derived ID is generated at the constant intervals has been described. However, the interval m may be an unfixed interval, or may be determined in any manner.

For example, in a case where the interval m is always constant, regularity that the derived IDs are always associated with m user data is caused. Therefore, to increase security while improving the anonymity without causing such regularity, the interval m may be made larger as the number of recorded user data, that is, the value of the number of recorded data x becomes larger. As such an example, for example, a square root of the number of recorded data x may be employed as the interval m, or a logarithm value of the number of recorded data x may be employed as the interval m.

### Third Embodiment

### <Recording of User Data>

By the way, in the first and second embodiments, the data management apparatus 11 needs to manage the number of recorded data x with a table or the like. If the number of recorded data x is managed by the data management apparatus 11 in that manner, the amount of data to be managed is increased, and a third party may know the numbers of recorded data x of users.

Therefore, user data may be managed without requiring the number of recorded data x, by generating a derived ID, using recorded user data of a specific type.

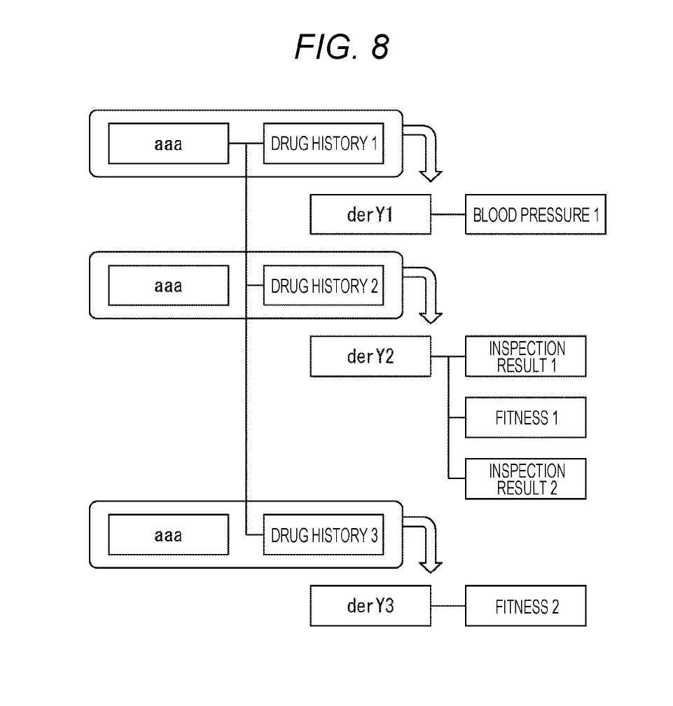

In such a case, a recording unit 23 records the user data, as illustrated in FIG. 8, for example. In the example of FIG. 8, “drug history 1”, “drug history 2”, and “drug history 3” are recorded as the recorded user data in association with “aaa” that is a user identification ID.

In this example, the derived ID is generated using data of the drug history of the user as the recorded user data of a specific type. Note that the type of the user data used to generate the derived ID may be one type or may be a plurality of types. Hereinafter, description will be given, where one type is used to generate the derived ID. Further, hereinafter, the type of the user data used to generate the derived ID is especially referred to as type for generating ID.

Further, in this example, a derived ID “derY1” is generated from the “drug history 1” that is the user data of the type for generating ID and the user identification ID “aaa”, and user data “blood pressure 1” of another type that is not the type for generating ID is recorded in association with the derived ID “derY1”.

Similarly, a derived ID “derY2” is generated from the “drug history 2” that is the user data of the type for generating ID and the user identification ID “aaa”, and user data “inspection result 1”, “fitness 1”, and “inspection result 2” of other types that are not the type for generating ID are recorded in association with the derived ID “derY2”. Further, a derived ID “derY3” is generated from the “drug history 3” that is the user data of the type for generating ID and the user identification ID “aaa”, and user data “fitness 2” of another type that is not the type for generating ID is recorded in association with the derived ID “derY3”.

In a case where the user data of the type for generating ID is recorded in association with the user identification ID, and the user data of another type that is not the type for generating ID is recorded in association with the derived ID in this way, whether user data is the data of the type for generating ID is determined in newly recording the user data.

Then, in a case where the user data intended to record is the data of the type for generating ID, the user data is recorded in association with the user identification ID.

In contrast, in a case where the user data intended to record is data of a type different from the type for generating ID, the derived ID is generated from the most recently recorded user data of the type for generating ID and the user identification ID, and the user data is recorded in association with the derived ID.

Therefore, a new derived ID is generated every time user data of a predetermined type for generating ID is recorded, to be specific, in a case where the user data of the type for generating ID is recorded and next the user data of a type different from the type for generating ID is recorded.

To be specific, in the example of FIG. 8, the “drug history 1” is first recorded as the user data, and after that, the “blood pressure 1” is recorded. Then, the “drug history 2” is further recorded as the user data, and then the “test value 1”, the “fitness 1”, and the “test value 2” are recorded. Next, the “drug history 3” is recorded, and the “fitness 2” is lastly recorded.

By recording the user data in such a procedure (algorithm), not only anonymity can be secured, but also the user data can be managed without requiring the number of recorded data x, and security can be further improved.

### <Description of Data Recording Process>

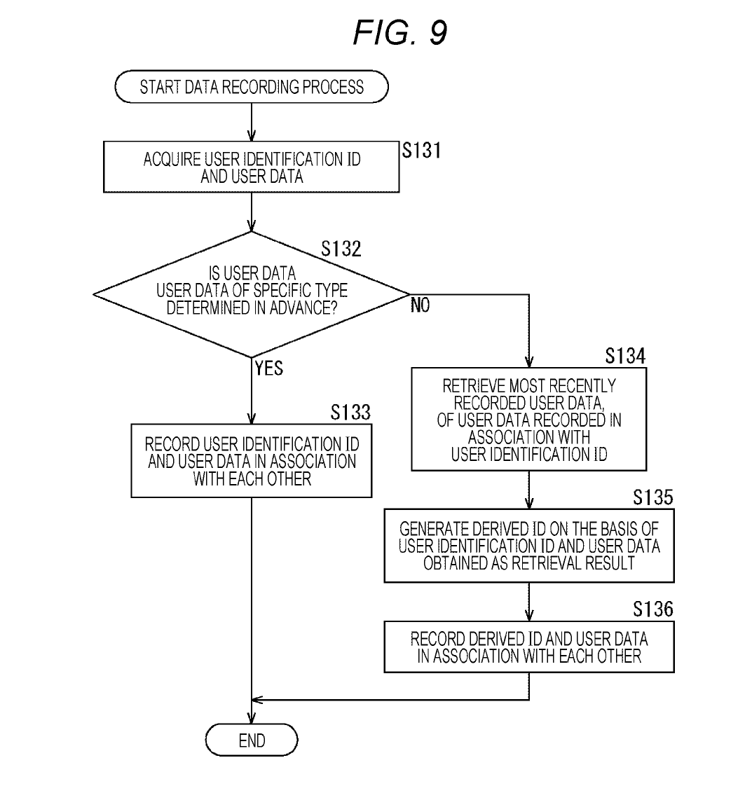

Next, a data recording process performed by a data management apparatus 11 in a case where the derived ID is generated from the user data of a specific type will be described with reference to the flowchart of FIG. 9. Note that the process of step S131 is similar to the process of step S11 of FIG. 3, and thus description thereof is omitted.

In step S132, a derived ID generation unit 31 determines whether or not the user data acquired by an acquisition unit 21 in the process of step S131 is the user data of a predetermined specific type, that is, the user data of the type for generating ID. For example, in the example of FIG. 8, in a case where the user data is data of drug history, the user data is determined to be the user data of the specific type.

Note that the type of the user data may be made identifiable from a data format of the user data by adding, for example, information of a flag that indicates the type of the user data to a head portion of the user data.

Alternatively, for example, when the acquisition unit 21 acquires the user identification ID and the user data from an information terminal apparatus, the acquisition unit 21 may acquire the information that indicates the type of the user data. Further, the type of the user data may be determined in advance for each information terminal apparatus that is an acquisition source of the user data.

In step S132, in a case where the user data is determined as the user data of the predetermined specific type, the process proceeds to step S133.

In step S133, a recording control unit 32 supplies the user identification ID and the user data acquired in the process of step S131 to a recording unit 23, and causes the recording unit 23 to record the user identification ID and the user data in association with each other. When the user data is recorded in this way, the data recording process is terminated.

In contrast, in a case where the user data is determined not to be the user data of the predetermined specific type in step S132, the process proceeds to step S134.

In step S134, a retrieval unit 33 retrieves (identifies) the most recently recorded user data, of the user data recorded in the recording unit 23 in association with the user identification ID acquired in the process of step S131. Then, the retrieval unit 33 reads out the user data obtained as a result of the retrieval from the recording unit 23.

For example, the retrieval unit 33 obtains the most recently recorded user data associated with the user identification ID, by retrieving the user data with latest date and time recorded in the recording unit 23, from update date and time or the like included in metadata of the user data. Further, for example, in a case where the user data associated with the user identification ID is arranged and recorded in order of recording, the retrieval unit 33 can identify the most recently recorded user data from a recording position of the user data.

For example, in the example illustrated in FIG. 8, the most recently recorded user data “drug history 3”, of the “drug history 1” to “drug history 3” recorded in association with the user identification ID “aaa”, is retrieved in the process of step S134.

With such a process, the latest user data, that is, the most recently recorded user data, of the user data of the type for generating ID, can be obtained.

In step S135, the derived ID generation unit 31 generates the derived ID on the basis of the user identification ID acquired in step S131, and the user data obtained as a result of the retrieval in the process of step S134.

For example, the derived ID generation unit 31 uses data obtained by combining the user identification ID and the user data as an argument, and assigns the argument to a one-way function F and carries out an operation to generate the derived ID.

In step S136, the recording control unit 32 supplies the derived ID generated in the process of step S135 and the user data acquired in the process of step S131 to the recording unit 23, and causes the recording unit 23 to record the derived ID and the user data in association with each other. When the user data is recorded in this way, the data recording process is terminated.

As described above, the data management apparatus 11 generates the derived ID according to the type of the user data to be recorded, and records the derived ID in association with the user data or records the user identification ID in association with the user data. Accordingly, anonymity, especially, K-anonymity of the user data can be improved.

Furthermore, the data management apparatus 11 generates the derived ID, using the user data, without using the number of recorded data x, and thus not only can reduce the amount of data to be managed, but also can improve security of user data management.

Further, if the user identification ID and the derived ID are made to information of the same size, such as a character string of 64 letters, a third party cannot distinguish the user identification ID and the derived ID, and also cannot identify which ID belongs to which user. Therefore, the anonymity of the data to be managed can be further improved.

Note that, in this embodiment, the user data of the type for generating ID is recorded in association with the user identification ID. However, the user identification ID is information with inherently high anonymity, and thus anonymity does not decrease even if the user data is recorded in association with the user identification ID.

### <Description of Readout Process>

Next, a readout process performed in a case where the user data is recorded in the data recording process described with reference to FIG. 9 will be described.

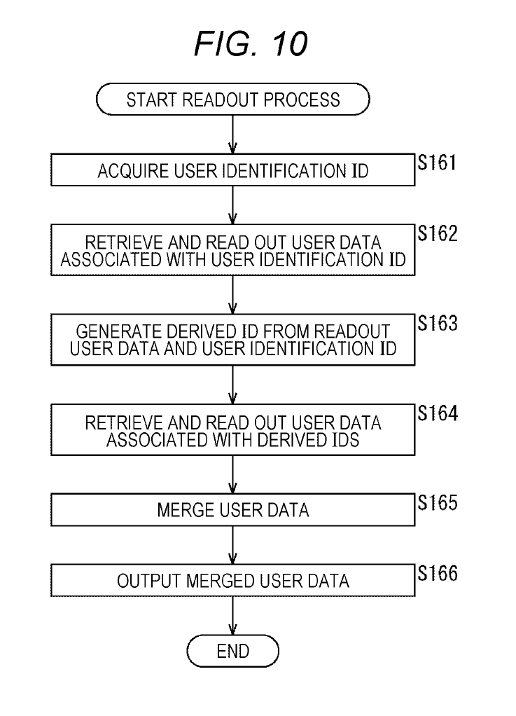

That is, hereinafter, the readout process performed by the data management apparatus 11 will be described with reference to the flowchart of FIG. 10. Note that the process of step S161 is similar to the process of step S41 of FIG. 4, and thus description thereof is omitted.

In step S162, the retrieval unit 33 retrieves the user data recorded in the recording unit 23 in association with the user identification ID acquired in the process of step S161, and reads out all the user data obtained as a result of the retrieval from the recording unit 23 and temporarily holds the user data.

In step S163, the derived ID generation unit 31 generates the derived ID, for all the user data read out in the process of step S162, on the basis of all the user data, and the user identification ID acquired in the process of step S161.

For example, the derived ID generation unit 31 uses the data obtained by combining the user identification ID and the user data as an argument, and assigns the argument to the one-way function F and carries out an operation to generate the derived ID.

Accordingly, the derived IDs are obtained by the number of the user data read out in the process of step S162. For example, in the example illustrated in FIG. 8, the “drug history 1”, the “drug history 2”, and the “drug history 3” are read out as the user data in step S162, and the derived IDs “derY1”, “derY2”, and “derY3” are generated for the “drug history 1” to “drug history 3” in step S163.

In step S164, the retrieval unit 33 retrieves the user data recorded in the recording unit 23 in association with the derived IDs generated in the process of step S163, and reads out all the user data obtained as a result of the retrieval from the recording unit 23 and temporarily holds the user data.

In step S165, the retrieval unit 33 merges all the user data obtained as a result of the retrieval, that is, all the user data read out in the processes of steps S162 and S164, and supplies the merged user data to an output unit 24.

Then, after that, the process of step S166 is performed and the readout process is terminated. The process of step S166 is similar to the process of step S49 of FIG. 4, and thus description thereof is omitted.

As described above, the data management apparatus 11 reads out the user data of the specific type on the basis of the user identification ID, generates the derived ID on the basis of the read-out user data and the user identification ID, and reads out the user data recorded in association with the derived ID.

In this case also, a third party who does not know a generation algorithm of the derived IDs cannot identify which derived ID belong to the same user, and also cannot distinguish the user identification ID and the derived ID. In this way, only a management side of the user data can reads out all the user data recorded about the user identification ID, whereby the anonymity of the user data can be improved.

### Fourth Embodiment

### <Recording of User Data>

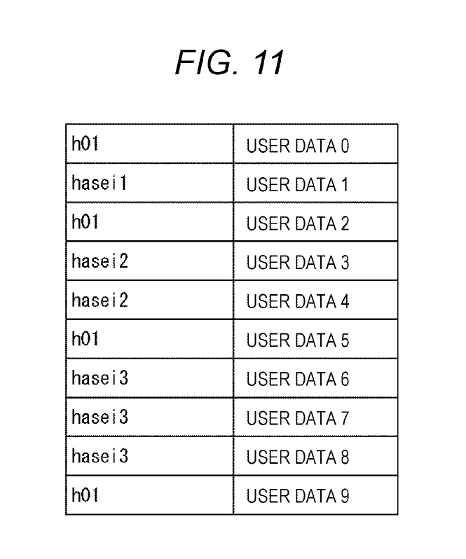

Further, as a method of generating a reasonable number of derived IDs in a hierarchical manner according to an increase/decrease in user data, without requiring the number of recorded data x, and managing the user data, a method of managing the user data, as illustrated in FIG. 11, can be considered.

In the example illustrated in FIG. 11, “user data 0” to “user data 9” that are user data are recorded in association with any of “h01” that is a user identification ID, and “hasei1”, “hasei2”, and “hasei3” that are derived IDs in a recording unit 23.

In this example, the derived IDs are generated by an algorithm below and the user data are recorded.

That is, first, the user data is recorded in association with the user identification ID. In FIG. 11, the user data “user data 0” is recorded in association with the user identification ID “h01”.

Next, the derived ID is generated from the number n of the user data recorded in association with the user identification ID and the user identification ID, and the user data is recorded in association with the derived ID. Here, the user data “user data 1” is recorded in association with the derived ID “hasei1” generated from the user identification ID “h01” and the number n=1.

After that, the user data to be subsequently recorded is recorded in association with the derived ID until the number hn of the user data recorded in association with the most recently generated derived ID becomes equal to the above-described number n.

Then, when the number hn becomes equal to the number n, new user data is recorded in association with the user identification ID. Further, as for user data next to the new user data, the derived ID is newly generated and the user data is recorded in association with the derived ID, and a process in which the user data is recorded in association with the newly generated derived ID is repeated until the number hn becomes equal to the number n.

For example, when the user data “user data 1” is recorded, the number n of the user data recorded in association with the user identification ID is 1, and the number hn of the user data recorded in association with the derived ID “hasei1” is 1.

In this case, the number n=1 and the number hn=1 are equal, and thus the “user data 2” following the user data “user data 1” is recorded in association with the user identification ID “h01”.

Then, after that, the derived ID “hasei2” is newly generated, and the user data is recorded in association with the derived ID “hasei2” until the number hn of the user data recorded in association with the derived ID “hasei2” becomes equal to the number n=2 of this point of time.

Here, the “user data 3” and the “user data 4” are recorded as the user data in association with the derived ID “hasei2”.

Further, after that, similarly, the user data “user data 5” is recorded in association with the user identification ID “h01”, the derived ID “hasei3” is generated, and the user data “user data 6” to “user data 8” are recorded in association with the derived ID “hasei3”. Further, after that, the user data “user data 9” is recorded in association with the user identification ID “h01”.

As described above, the derived ID is newly generated every time (n+1) user data are recorded, and the user data are recorded in association with the derived ID, whereby anonymity of the user data can be improved.

Especially, in this example, the number hn of the user data recorded in association with the newly generated derived ID becomes larger as the number of recorded user data is increased, that is, the number n of the user data recorded in association with the user identification ID becomes larger. Therefore, identification of regularity is difficult. Further, in the recording unit 23, a table in which the user identification ID and the number of recorded data x are associated and the like are not recorded. Therefore, it is difficult for a third party who cannot grasp association relationship between the derived IDs and the user identification ID to identify the algorithm to record the user data.

### <Description of Data Recording Process>

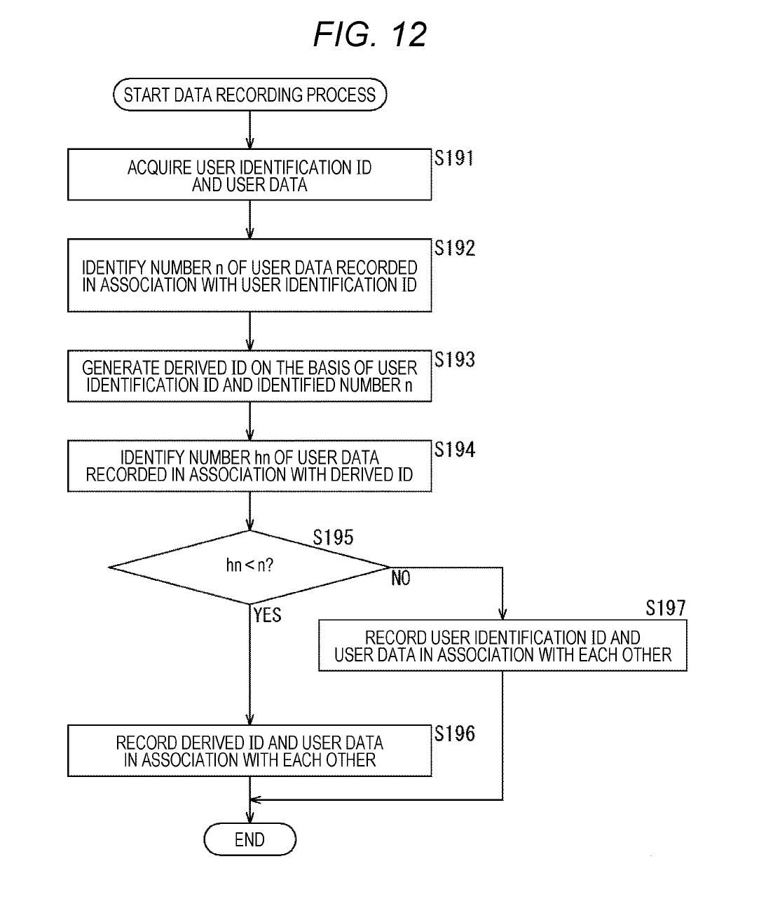

Next, a data recording process performed by a data management apparatus 11 in a case where the user data are recorded by the algorithm described with reference to FIG. 11 will be described with reference to the flowchart of FIG. 12. Note that the process of step S191 is similar to the process of step S11 of FIG. 3, and thus description thereof is omitted.

In step S192, a retrieval unit 33 performs retrieval on the basis of the user identification ID acquired in the process of step S191, and identifies the number n of the user data recorded in the recording unit 23 in association with the user identification ID.

In step S193, a derived ID generation unit 31 generates the derived ID on the basis of the user identification ID acquired by an acquisition unit 21 in the process of step S191 and the number n identified in the process of step S192.

For example, the derived ID generation unit 31 uses data obtained by adding a value of the number n to the tail end of the user identification ID as an argument, assigns the argument to a one-way function F and performs an operation, and employs a value obtained as a result of the operation as the derived ID.

Note that, alternatively, the derived ID may be calculated such that the most recently recorded user data, of the user data recorded in the recording unit 23 in association with the user identification ID, is added to the tail end of the user identification ID and is used as the argument, and the argument is assigned to the one-way function F.

In step S194, the retrieval unit 33 performs retrieval on the basis of the derived ID generated in the process of step S193, and identifies the number hn of the user data recorded in the recording unit 23 in association with the derived ID.

In step S195, a recording control unit 32 determines whether or not hn<n is satisfied. That is, the recording control unit 32 determines whether or not the number hn identified in step S194 is less than the number n identified in step S192.

Note that, here, the example of comparing the number hn and the number n is described. However, a threshold for determining whether the number hn of the user data associated with the derived ID is a predetermined number or less is not limited to the number n, and may be any value such as a value obtained by assigning the number n to a predetermined function. For example, the threshold may be a value determined on the basis of the number n or may be a fixed value.

In step S195, in a case where it has been determined that hn<n is satisfied, the process proceeds to step S196.

In step S196, the recording control unit 32 supplies the derived ID generated in the process of step S193, and the user data acquired in the process of step S191 to the recording unit 23, and causes the recording unit 23 to record the derived ID and the user data in association with each other. When the user data is recorded in this way, the data recording process is terminated.

In contrast, in a case where it has been determined that hn<n is not satisfied in step S195, the process proceeds to step S197.

In step S197, the recording control unit 32 supplies the user identification ID acquired in the process of step S191 and the user data to the recording unit 23, and causes the recording unit 23 to record the user identification ID and the user data in association with each other. The user data is recorded in this way, the data recording process is terminated.

As described above, the data management apparatus 11 generates the derived ID on the basis of the number n of the user data associated with the user identification ID and the user identification ID. Further, the data management apparatus 11 compares the number n and the number hn, and records the user data in association with the derived ID or records the user data in association with the user identification ID, according to the comparison result.

Accordingly, the anonymity of the user data can be improved. Especially, the data management apparatus 11 appropriately generates the derived ID according to an increase in the recorded user data, and thus can improve the K-anonymity.

### <Description of Readout Process>

Next, a readout process performed in a case where the user data is recorded in the data recording process described with reference to FIG. 12 will be described.

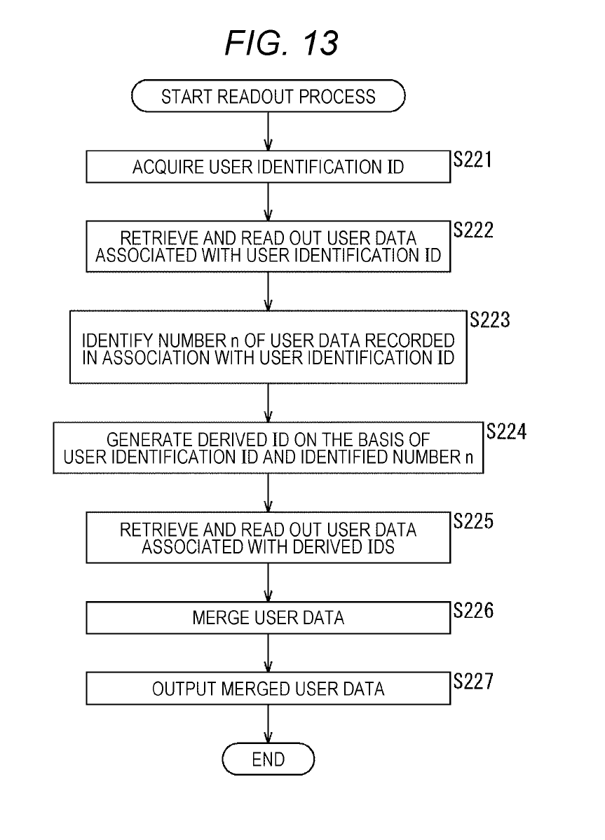

That is, hereinafter, a readout process performed by the data management apparatus 11 will be described with reference to the flowchart of FIG. 13. Note that the process of step S221 is similar to the process of step S41 of FIG. 4, and thus description thereof is omitted.

In step S222, the retrieval unit 33 retrieves the user data recorded in the recording unit 23 in association with the user identification ID acquired in the process of step S221, and reads out all the user data obtained as a result of the retrieval from the recording unit 23 and temporarily holds the user data.

In step S223, the retrieval unit 33 identifies the number n of the user data recorded in the recording unit 23 in association with the user identification ID by identifying the number of the user data recorded in the process of step S222.

In step S224, the derived ID generation unit 31 generates the derived ID on the basis of the user identification ID acquired by the acquisition unit 21 in the process of step S221 and the number n identified in the process of step S223.

For example, the derived ID generation unit 31 uses a value 1 of a counter n′ corresponding to the number n, employs data obtained by adding the value of the counter n′ to the tail end of the user identification ID as the argument, and assigns the argument to the one-way function F and performs an operation, and employs a value obtained as a result of the operation as the derived ID.

Then, the derived ID generation unit 31 generates the derived ID for the values of the counter n′ while incrementing the value of the counter n′ by 1 until the value of the counter n′ becomes n′=n. Accordingly, a total of n derived IDs can be obtained.

In step S225, the retrieval unit 33 retrieves the user data recorded in the recording unit 23 in association with the derived IDs generated in the process of step S224, and reads out all the user data obtained as a result of the retrieval from the recording unit 23 and temporarily holds the user data.

In step S226, the retrieval unit 33 merges all the user data obtained as a result of the retrieval, that is, all the user data read out in the processes of steps S222 and S225, and supplies the merged user data to an output unit 24.

Then, after that, the process of step S227 is performed and the readout process is terminated. The process of step S227 is similar to the process of step S49 of FIG. 4, and thus description thereof is omitted. Note that, in the readout process, the number of all the user data can be estimated at the point of time when the number n is identified, and thus a time necessary for the merging process of the user data can be estimated. Therefore, wait time of the process may be presented to a user or the like at appropriate timing.

As described above, the data management apparatus 11 reads out the user data associated with the user identification ID, generates the derived ID on the basis of the number n of the read-out user data and the user identification ID, and reads out the user data associated with the derived ID.

In this case also, a third party cannot identify which derived IDs belong to the same user, and also cannot distinguish the user identification ID and the derived ID. In this way, only a management side of the user data can read out all the user data recorded about the user identification ID, whereby the anonymity of the user data can be improved.

Further, in the above first to fourth embodiments, the generation of the derived ID and the recording of the user data have been performed according to the algorithms different from one another. The generation of the derived ID and the recording of the user data may be performed by selecting any of the algorithms. In such a case, for example, it is sufficient that information indicating selectable algorithms is recorded in the recording unit 23, and the algorithm is selected for each user and the user data may be recorded. Further, in this case, it is sufficient that information indicating a selection result such that which user has selected which algorithm can be understood may be recorded. Further, a specific algorithm is selected according to a type of the user data.

Further, in the above description, the examples of generating the derived ID, using the recorded user data of a specific type, such as the number of recorded data or the data of drug history have been described. However, alternatively, the derived ID may be generated using information regarding the user such as an age of the user, information regarding the user data such as recording date and time, or a type of the user data, or the like. Further, the derived ID may be controlled to be generated according to information of when the user data is recorded, such as the derived ID being generated every week or month.

By the way, a series of processes described above can be executed by hardware or by software. In a case where a series of processes is executed by software, a program that configures the software is installed in a computer. Here, the computer includes a computer incorporated in dedicated hardware, for example, a general-purpose personal computer capable of executing various functions by installing various programs, and the like.

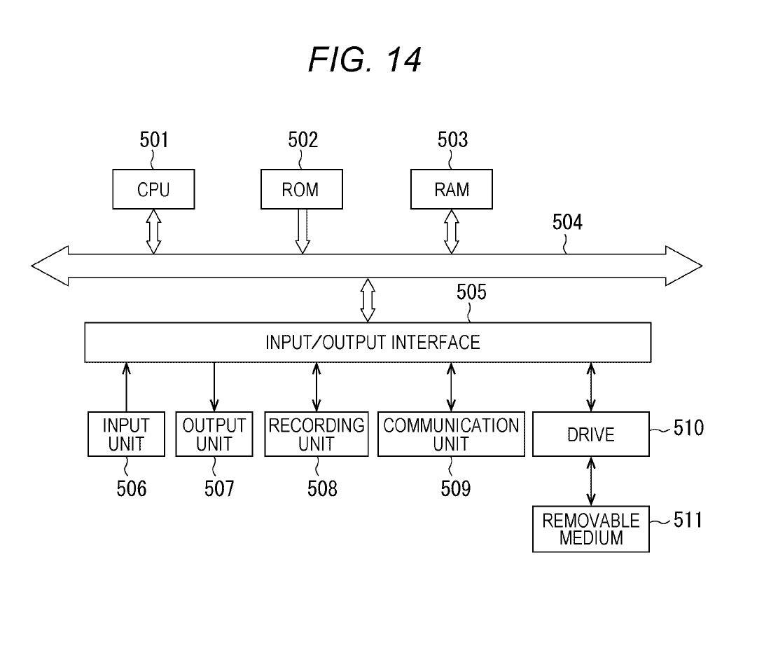

FIG. 14 is a block diagram illustrating a configuration example of hardware of a computer that executes a series of processes described above by a program.

A central processing unit (CPU) 501, a read only memory (ROM) 502, and a random access memory (RAM) 503 are connected to one another by a bus 504 in the computer.

An input/output interface 505 is further connected to the bus 504. An input unit 506, an output unit 507, a recording unit 508, a communication unit 509, and a drive 510 are connected to the input/output interface 505.

The input unit 506 includes a keyboard, a mouse, a microphone, an imaging element, and the like. The output unit 507 includes a display, a speaker, and the like. The recording unit 508 includes a hard disk, a non-volatile memory, and the like. The communication unit 509 includes a network interface, and the like. The drive 510 drives a removable medium 511 such as a magnetic disk, an optical disk, a magneto-optical disk, or a semiconductor memory.

In the computer configured as described above, the CPU 501 loads a program recorded in the recording unit 508, for example, through the input/output interface 505 and the bus 504 into the RAM 503 and the bus 504 and executes the program, and thus the series of processes described above is performed.

The program executed by the computer (CPU 501) can be recorded in and provided with the removable medium 511 such as a package medium. Alternatively, the program can be provided through a wired or wireless medium such as a local area network, the Internet, or digital satellite broadcasting.

In the computer, the removable medium 511 is mounted to the drive 510, and the program can be installed into the recording unit 508 through the input/output interface 505. Alternatively, the program can be received by the communication unit 509 through the wired or wireless transmission medium and installed into the recording unit 508. Further, the program can be installed into the ROM 502 or the recording unit 508 in advance.

Note that the program executed by the computer may be a program by which the processes are performed in time series according to the order described in the present specification, or may be a program by which the processes are performed in parallel or at necessary timing upon being called.

Further, embodiments of the present technology are not limited to the above-described embodiments, and various changes can be made without departing from the scope of the present technology.

For example, the present technology can have a configuration of cloud computing in which one function is divided into and processed by a plurality of apparatuses, and processed in cooperation by the plurality of apparatuses, through a network.

Further, each step described in the above-described flowcharts can be executed by one apparatus or can be divided into and executed by a plurality of apparatuses.

Further, in a case where a plurality of processes is included in one step, the plurality of processes included in the step can be executed by one apparatus or can be divided into and executed by a plurality of apparatuses.

Further, the present technology can have the configurations below.

[1]

An information processing apparatus including:

an acquisition unit configured to acquire personal identification information that identifies a user and data to be recorded;

a derived identification information generation unit configured to generate derived identification information from the personal identification information on the basis of the number of already recorded recorded data; and

a recording control unit configured to control such that the derived identification information or the personal identification information, and the data to be recorded are recorded in association with each other.

[2]

The information processing apparatus according to [1], in which

the derived identification information generation unit generates the derived identification information by carrying out an operation using a one-way function for the personal identification information.

[3]

The information processing apparatus according to [1] or [2], in which

the derived identification information generation unit generates the derived identification information from the already recorded recorded data and the personal identification information.

[4]

The information processing apparatus according to any one of [1] to [3], in which

the derived identification information generation unit generates new derived identification information every time a predetermined number of the data to be recorded is recorded as the recorded data.

[5]

The information processing apparatus according to any one of [4], in which

the predetermined number is changed according to the number of the recorded data.

[6]

The information processing apparatus according to any of [1] to [5], in which

the recording control unit controls such that the data to be recorded are recorded in association with the personal identification information or the generated derived identification information on the basis of the number of the recorded data recorded in association with the generated derived identification information, and the number of the recorded data recorded in association with the personal identification information.

[7]

An information processing apparatus including:

an acquisition unit configured to acquire personal identification information that identifies a user and data to be recorded;

a derived identification information generation unit configured to generate derived identification information from the personal identification information on the basis of the data to be recorded; and

a recording control unit configured to control such that the derived identification information or the personal identification information, and the data to be recorded are recorded in association with each other.

[8]

The information processing apparatus according to [7], in which

the derived identification information generation unit generates the derived identification information from already recorded recorded data and the personal identification information.

[9]

The information processing apparatus according to [8], in which

the derived identification information generation unit generates the derived identification information by carrying out an operation using a one-way function for data obtained from the most recently recorded recorded data and the personal identification information.

[10]

The information processing apparatus according to [7], in which

the derived identification information generation unit generates the derived identification information on the basis of a type or recording date and time of the data to be recorded.

[11]

The information processing apparatus according to any one of [7] to [10], in which

the derived identification information generation unit generates the derived identification information in a case where the data to be recorded acquired from the acquisition unit is different from predetermined data to be recorded.

[12]

The information processing apparatus according to any one of [7] to [11], in which

the recording control unit controls such that the data to be recorded are recorded in association with the personal identification information or the derived identification information on the basis of the data to be recorded.

[13]

An information processing method including the steps of:

acquiring personal identification information that identifies a user and data to be recorded;

generating derived identification information from the personal identification information on the basis of the number of already recorded recorded data; and

controlling such that the derived identification information or the personal identification information, and the data to be recorded are recorded in association with each other.

[14]

A program for causing a computer to execute processing including the steps of:

acquiring personal identification information that identifies a user and data to be recorded;

generating derived identification information from the personal identification information on the basis of the number of already recorded recorded data; and

controlling such that the derived identification information or the personal identification information, and the data to be recorded are recorded in association with each other.

[15]

An information processing method including the steps of:

acquiring personal identification information that identifies a user and data to be recorded;

generating derived identification information from the personal identification information on the basis of the data to be recorded; and

controlling such that the derived identification information or the personal identification information, and the data to be recorded are recorded in association with each other.

[16]

A program for causing a computer to execute processing including the steps of:

acquiring personal identification information that identifies a user and data to be recorded;

generating derived identification information from the personal identification information on the basis of the data to be recorded; and

controlling such that the derived identification information or the personal identification information, and the data to be recorded are recorded in association with each other.

[17]

An information processing apparatus that generates derived identification information from personal identification information that identifies a user on the basis of the number of already recorded record data, and reads out the record data recorded in a recording unit in association with the derived identification information or the personal identification information, the information processing apparatus including:

a derived identification information generation unit configured to generate the derived identification information from the personal identification information; and

a readout unit configured to read out the record data recorded in association with the generated derived identification information or the personal identification information.

[18]

The information processing apparatus according to [17], in which

the derived identification information generation unit generates the derived identification information by carrying out an operation using a one-way function for the personal identification information.

[19]

The information processing apparatus according to [17], in which

the derived identification information generation unit generates the derived identification information from the record data recorded in association with the personal identification information and the personal identification information.

[20]

The information processing apparatus according to [17], in which

the derived identification information generation unit generates the derived identification information from a predetermined number and the personal identification information.

[21]

The information processing apparatus according to [20], in which

the derived identification information generation unit changes the predetermined number at constant intervals or at unfixed intervals.

[22]

The information processing apparatus according to [17], in which

the derived identification information generation unit generates the derived identification information on the basis of the number of the record data recorded in association with the personal identification information.

[23]

An information processing apparatus that generates derived identification information from personal identification information that identifies a user on the basis of record data that is an object to be recorded, and reads out the record data recorded in a recording unit in association with the derived identification information or the personal identification information, the information processing apparatus including:

a derived identification information generation unit configured to generate the derived identification information from the personal identification information; and

a readout unit configured to read out the record data recorded in association with the generated derived identification information or the personal identification information.

[24]

The information processing apparatus according to [23], in which

the derived identification information generation unit generates the derived identification information from the record data recorded in association with the personal identification information and the personal identification information.

[25]

The information processing apparatus according to [24], in which

the derived identification information generation unit generates the derived identification information by carrying out an operation using a one-way function for data obtained from the record data recorded in association with the personal identification information and the personal identification information.

[26]

The information processing apparatus according to [23], in which

the derived identification information generation unit generates the derived identification information on the basis of a type or recording date and time of the record data recorded in association with the personal identification information.

### REFERENCE SIGNS LIST

11 Data management apparatus
21 Acquisition unit
22 Control unit
23 Recording unit
31 Derived ID generation unit
32 recording control unit
33 Retrieval unit

1. An information processing apparatus comprising:
an acquisition unit configured to acquire personal identification information that identifies a user and data to be recorded;
a derived identification information generation unit configured to generate derived identification information from the personal identification information on the basis of the number of already recorded recorded data; and
a recording control unit configured to control such that the derived identification information or the personal identification information, and the data to be recorded are recorded in association with each other.

2. The information processing apparatus according to claim 1, wherein
the derived identification information generation unit generates the derived identification information by carrying out an operation using a one-way function for the personal identification information.

3. The information processing apparatus according to claim 1, wherein
the derived identification information generation unit generates the derived identification information from the already recorded recorded data and the personal identification information.

4. The information processing apparatus according to claim 1, wherein
the derived identification information generation unit generates new derived identification information every time a predetermined number of the data to be recorded is recorded as the recorded data.

5. The information processing apparatus according to claim 4, wherein
the predetermined number is changed according to the number of the recorded data.

6. The information processing apparatus according to claim 1, wherein
the recording control unit controls such that the data to be recorded are recorded in association with the personal identification information or the generated derived identification information on the basis of the number of the recorded data recorded in association with the generated derived identification information, and the number of the recorded data recorded in association with the personal identification information.

7. An information processing apparatus comprising:
an acquisition unit configured to acquire personal identification information that identifies a user and data to be recorded;
a derived identification information generation unit configured to generate derived identification information from the personal identification information on the basis of the data to be recorded; and
a recording control unit configured to control such that the derived identification information or the personal identification information, and the data to be recorded are recorded in association with each other.

8. The information processing apparatus according to claim 7, wherein
the derived identification information generation unit generates the derived identification information from already recorded recorded data and the personal identification information.

9. The information processing apparatus according to claim 8, wherein
the derived identification information generation unit generates the derived identification information by carrying out an operation using a one-way function for data obtained from the most recently recorded recorded data and the personal identification information.

10. The information processing apparatus according to claim 7, wherein
the derived identification information generation unit generates the derived identification information on the basis of a type or recording date and time of the data to be recorded.

11. The information processing apparatus according to claim 7, wherein
the derived identification information generation unit generates the derived identification information in a case where the data to be recorded acquired from the acquisition unit is different from predetermined data to be recorded.

12. The information processing apparatus according to claim 7, wherein
the recording control unit controls such that the data to be recorded are recorded in association with the personal identification information or the derived identification information on the basis of the data to be recorded.

13. An information processing method comprising the steps of:
acquiring personal identification information that identifies a user and data to be recorded;
generating derived identification information from the personal identification information on the basis of the number of already recorded recorded data; and
controlling such that the derived identification information or the personal identification information, and the data to be recorded are recorded in association with each other.

14. A program for causing a computer to execute processing comprising the steps of:
acquiring personal identification information that identifies a user and data to be recorded;
generating derived identification information from the personal identification information on the basis of the number of already recorded recorded data; and
controlling such that the derived identification information or the personal identification information, and the data to be recorded are recorded in association with each other.

15. An information processing method comprising the steps of:
acquiring personal identification information that identifies a user and data to be recorded;
generating derived identification information from the personal identification information on the basis of the data to be recorded; and
controlling such that the derived identification information or the personal identification information, and the data to be recorded are recorded in association with each other.

16. A program for causing a computer to execute processing comprising the steps of:
acquiring personal identification information that identifies a user and data to be recorded;
generating derived identification information from the personal identification information on the basis of the data to be recorded; and
controlling such that the derived identification information or the personal identification information, and the data to be recorded are recorded in association with each other.

17. An information processing apparatus that generates derived identification information from personal identification information that identifies a user on the basis of the number of already recorded record data, and reads out the record data recorded in a recording unit in association with the derived identification information or the personal identification information, the information processing apparatus comprising:
a derived identification information generation unit configured to generate the derived identification information from the personal identification information; and
a readout unit configured to read out the record data recorded in association with the generated derived identification information or the personal identification information.

18. The information processing apparatus according to claim 17, wherein
the derived identification information generation unit generates the derived identification information by carrying out an operation using a one-way function for the personal identification information.

19. The information processing apparatus according to claim 17, wherein
the derived identification information generation unit generates the derived identification information from the record data recorded in association with the personal identification information and the personal identification information.

20. The information processing apparatus according to claim 17, wherein
the derived identification information generation unit generates the derived identification information from a predetermined number and the personal identification information.

21. The information processing apparatus according to claim 20, wherein
the derived identification information generation unit changes the predetermined number at constant intervals or at unfixed intervals.

22. The information processing apparatus according to claim 17, wherein
the derived identification information generation unit generates the derived identification information on the basis of the number of the record data recorded in association with the personal identification information.

23. An information processing apparatus that generates derived identification information from personal identification information that identifies a user on the basis of record data that is an object to be recorded, and reads out the record data recorded in a recording unit in association with the derived identification information or the personal identification information, the information processing apparatus comprising:
a derived identification information generation unit configured to generate the derived identification information from the personal identification information; and
a readout unit configured to read out the record data recorded in association with the generated derived identification information or the personal identification information.

24. The information processing apparatus according to claim 23, wherein
the derived identification information generation unit generates the derived identification information from the record data recorded in association with the personal identification information and the personal identification information.

25. The information processing apparatus according to claim 24, wherein
the derived identification information generation unit generates the derived identification information by carrying out an operation using a one-way function for data obtained from the record data recorded in association with the personal identification information and the personal identification information.

26. The information processing apparatus according to claim 23, wherein
the derived identification information generation unit generates the derived identification information on the basis of a type or recording date and time of the record data recorded in association with the personal identification information.
